(19) United States
(12) Patent Application Publication
(10) Pub. No.: US 2016/0208922 A1
(43) Pub. Date: Jul. 21, 2016

(54) RADIALLY CAPTURED SEAL ASSEMBLY AND METHOD OF ASSEMBLY

(71) Applicant: United Technologies Corporation, Hartford, CT (US)

(72) Inventors: Christopher M. Juh, South Windsor, CT (US); George E. Allen, Manchester, CT (US)

(21) Appl. No.: 14/600,033

(22) Filed: Jan. 20, 2015

(51) Int. Cl. F16J 15/30

(52) U.S. Cl. CPC F16J 15/30

(57) ABSTRACT

A seal assembly may include a housing that supports a seal ring, which may be made of carbon. A radial restrictor of the assembly prevents undesired movement of any portion of the ring during assembly, and has an axially projecting protuberance rigidly engaged to one of the housing and the carbon seal ring, and a cavity defined by the other of the housing and the carbon seal ring for receipt of the protuberance. A clearance directly adjacent to and radially outward from the protuberance and within the cavity generally allows for wear of the ring and is equal to or greater than a pre-determined radial wear distance of the carbon ring seal.

### BACKGROUND

The present disclosure relates to a seal assembly, and more particularly, to a seal assembly having a radial restrictor for holding a carbon seal ring of the assembly in-place during assembly.

Seal assemblies are known to seal between stationary and rotating parts. One such seal assembly may seal to a cylindrical face carried by a bearing structure orientated about a rotating shaft or spool of, as one non-limiting example, a gas turbine engine. The assembly may include a carbon seal ring designed to prevent leakage of fluids such as oil, and collapse radially inward as the ring wears against the rotating cylindrical face. Such rings are often made of separate sealing elements each housed and extending circumferentially within a housing of the assembly. Moreover, a variety of other components may be positioned generally between the housing and the sealing elements. Proper positioning of the components may be dependent upon maintaining a desired position of each sealing element. Prior to complete assembly, or during assembly, the sealing elements are known to more unintentionally, thereby aggravating the assembly process.

### SUMMARY

A seal assembly according to one, non-limiting, embodiment of the present disclosure includes a housing orientated about an axis; a wearable seal ring supported by the housing; and a radial restrictor constructed and arranged between the housing and the seal ring, the radial restrictor including an axially projecting protuberance rigidly engaged to one of the housing and the seal ring, and a cavity defined by the other of the housing and the seal ring for receipt of the protuberance, and wherein a clearance directly adjacent to and radially outward from the protuberance and within the cavity is equal to or greater than a pre-determined radial wear distance of the ring seal when the ring seal is in an unworn state.

Additionally to the foregoing embodiment, the seal ring includes a plurality of carbon elements each extending circumferentially.

In the alternative or additionally thereto, in the foregoing embodiment, the radial restrictor is one of a plurality of radial restrictors and each one of the plurality of carbon elements is associated with at least a respective one of the plurality of radial restrictors.

In the alternative or additionally thereto, in the foregoing embodiment, the plurality of carbon elements is at least three carbon elements.

In the alternative or additionally thereto, in the foregoing embodiment, the assembly includes a structure in rotational relationship to the seal ring, and including a substantially cylindrical sealing face facing radially outward for sealing contact with an inward surface of the seal ring.

In the alternative or additionally thereto, in the foregoing embodiment, the structure is a bearing structure orientated about a rotating spool of a gas turbine engine.

In the alternative or additionally thereto, in the foregoing embodiment, the assembly includes a full hoop garter spring biased against an outward surface of the seal ring disposed opposite the inward surface for biasing the inward surface against the outward face.

In the alternative or additionally thereto, in the foregoing embodiment, the assembly includes a plurality of axially biasing members resiliently disposed between a radial first face of the housing and an opposed radial first surface of the seal ring for biasing a radial second surface of the seal ring disposed opposite the first surface toward a radial second face of the housing axially opposed to the first face.

In the alternative or additionally thereto, in the foregoing embodiment, the radial restrictor is carried between the second surface and the second face.

In the alternative or additionally thereto, in the foregoing embodiment, the protuberance rigidly projects axially from the second face.

In the alternative or additionally thereto, in the foregoing embodiment, the cavity communicates through the second surface.

In the alternative or additionally thereto, in the foregoing embodiment, the assembly includes a structure in rotational relationship to the seal ring, and including a substantially cylindrical sealing face facing radially outward for sealing contact with an inward surface of the seal ring, and wherein the cavity is spaced radially outward from the inward surface.

In the alternative or additionally thereto, in the foregoing embodiment, the assembly includes a structure in rotational relationship to the seal ring, and including a substantially cylindrical sealing face facing radially outward for sealing contact with an inward surface of the seal ring, and wherein the cavity communicates through the inward surface.

In the alternative or additionally thereto, in the foregoing embodiment, the protuberance is a circumferentially continuous rib and the cavity is a circumferentially continuous channel.

A seal assembly according to another, non-limiting, embodiment includes an annular housing orientated about an axis; a plurality of sealing elements distributed circumferentially within the housing; a spring constructed and arranged to bias the plurality of sealing elements radially inward; a plurality of resilient members, wherein at least one of the plurality of resilient members biases a respective one of the plurality of sealing elements axially against the housing; and a plurality of radial restrictors, wherein at least one of the plurality of radial restrictors is carried between the housing and a respective one of the plurality of sealing elements.

Additionally to the foregoing embodiment, the plurality of sealing elements are compressed axially between a first face of the housing and a first surface of each one of the plurality of sealing elements and a second surface of each one of the plurality of sealing elements is opposite the first surface and is biased against an annular second face of the housing that is opposed to the first face.

In the alternative or additionally thereto, in the foregoing embodiment, the second surface is in sealing relationship to the second face and is constructed and arranged to slide radially with respect to the second face as the plurality of sealing elements wear.

In the alternative or additionally thereto, in the foregoing embodiment, each one of the plurality of radial restrictors include an axially projecting protuberance rigidly engaged to one of the second face and the second surface, and a cavity communicating through the other of the second face and the second surface for receipt of the protuberance, and wherein a clearance directly adjacent to and radially outward from the protuberance and within the cavity is equal to or greater than a pre-determined radial wear distance of the carbon ring seal when the carbon ring seal is in an unworn state.

A method of assembling a seal assembly according to another, non-limiting, embodiment includes the steps of initiating a radial restrictor carried between an axially facing first surface of a sealing element and an axially facing first face of a housing via insertion of the sealing element into the housing; and biasing the first surface toward the first face via a resilient member.

Additionally to the foregoing embodiment, the resilient member is compressed between a second face of the housing opposed to the first face and a second surface of the sealing element disposed opposite the first surface.

The foregoing features and elements may be combined in various combinations without exclusivity, unless expressly indicated otherwise. These features and elements as well as the operation thereof will become more apparent in light of the following description and the accompanying drawings. It should be understood, however, the following description and figures are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a schematic cross section of a gas turbine engine;

FIG. 2 is an axial plan view of a seal assembly of the engine with portion removed to show internal detail;

FIG. 3 is a partial perspective view of the seal assembly;

FIG. 4 is a cross section of the seal assembly taken from circle 4 of FIG. 1;

FIG. 5 is an enlarged partial cross section of the seal assembly taken from circle 5 of FIG. 4; and

FIG. 6 is a cross section of a second embodiment of a seal assembly.

### DETAILED DESCRIPTION

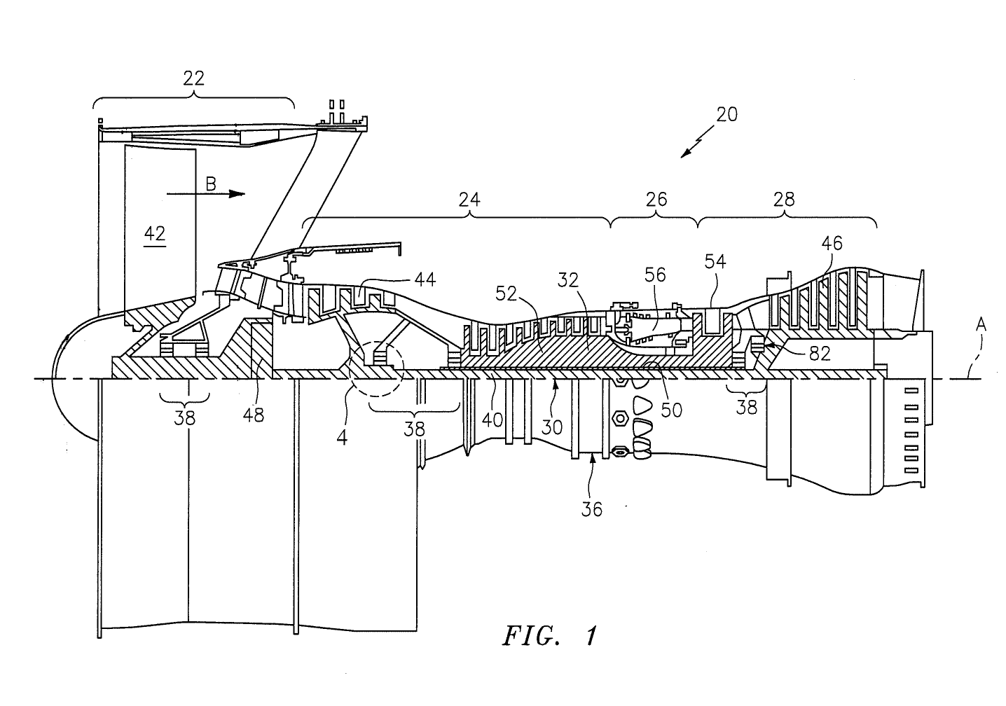

FIG. 1 schematically illustrates a gas turbine engine 20 disclosed as a two-spool turbo fan that generally incorporates a fan section 22, a compressor section 24, a combustor section 26 and a turbine section 28. The fan section 22 drives air along a bypass flowpath while the compressor section 24 drives air along a core flowpath for compression and communication into the combustor section 26 then expansion through the turbine section 28. Although depicted as a turbofan in the disclosed non-limiting embodiment, it should be understood that the concepts described herein are not limited to use with turbofans as the teachings may be applied to other types of turbine engine architecture such as turbojets, turboshafts, three-spool turbofans, land-based turbine engines, helicopter applications, and others.

The engine 20 generally includes a low spool 30 and a high spool 32 mounted for rotation about an engine axis A via several bearing structures 38 and relative to a static engine case 36. The low spool 30 generally includes an inner shaft 40 that interconnects a fan 42 of the fan section 22, a low pressure compressor 44 (“LPC”) of the compressor section 24 and a low pressure turbine 46 (“LPT”) of the turbine section 28. The inner shaft 40 drives the fan 42 directly, or, through a geared architecture 48 to drive the fan 42 at a lower speed than the low spool 30. An exemplary reduction transmission may be an epicyclic transmission, namely a planetary or star gear system.

The high spool 32 includes an outer shaft 50 that interconnects a high pressure compressor 52 (“HPC”) of the compressor section 24 and a high pressure turbine 54 (“HPT”) of the turbine section 28. A combustor 56 of the combustor section 26 is arranged between the HPC 52 and the HPT 54. The inner shaft 40 and the outer shaft 50 are concentric and rotate about the engine axis A. Core airflow is compressed by the LPC 44 then the HPC 52, mixed with the fuel and burned in the combustor 56, then expanded over the HPT 54 and the LPT 46. The LPT 46 and HPT 54 rotationally drive the respective low spool 30 and high spool 32 in response to the expansion.

In one non-limiting example, the gas turbine engine 20 is a high-bypass geared aircraft engine. In a further example, the gas turbine engine 20 bypass ratio is greater than about six (6:1). The geared architecture 48 can include an epicyclic gear train, such as a planetary gear system or other gear system. The example epicyclic gear train has a gear reduction ratio of greater than about 2.3:1, and in another example is greater than about 2.5:1. The geared turbofan enables operation of the low spool 30 at higher speeds that can increase the operational efficiency of the LPC 44 and LPT 46 and render increased pressure in a fewer number of stages.

A pressure ratio associated with the LPT 46 is pressure measured prior to the inlet of the LPT 46 as related to the pressure at the outlet of the LPT 46 prior to an exhaust nozzle of the gas turbine engine 20. In one non-limiting example, the bypass ratio of the gas turbine engine 20 is greater than about ten (10:1); the fan diameter is significantly larger than the LPC 44; and the LPT 46 has a pressure ratio that is greater than about five (5:1). It should be understood; however, that the above parameters are only exemplary of one example of a geared architecture engine and that the present disclosure is applicable to other gas turbine engines including direct drive turbofans.

In one non-limiting example, a significant amount of thrust is provided by the bypass flow path B due to the high bypass ratio. The fan section 22 of the gas turbine engine 20 is designed for a particular flight condition—typically cruise at about 0.8 Mach and about 35,000 feet (10,668 meters). This flight condition, with the gas turbine engine 20 at its best fuel consumption, is also known as Thrust Specific Fuel consumption (TSFC). TSFC is an industry standard parameter of fuel consumption per unit of thrust.

Fan Pressure Ratio is the pressure ratio across a blade of the fan section 22 without the use of a fan exit guide vane system. The low Fan Pressure Ratio according to one, non-limiting, example of the gas turbine engine 20 is less than 1.45:1. Low Corrected Fan Tip Speed is the actual fan tip speed divided by an industry standard temperature correction of (T/518.7)^{0.5}, where “T” represents the ambient temperature in degrees Rankine. The Low Corrected Fan Tip Speed according to one non-limiting example of the gas turbine engine 20 is less than about 1,150 feet per second (351 meters per second).

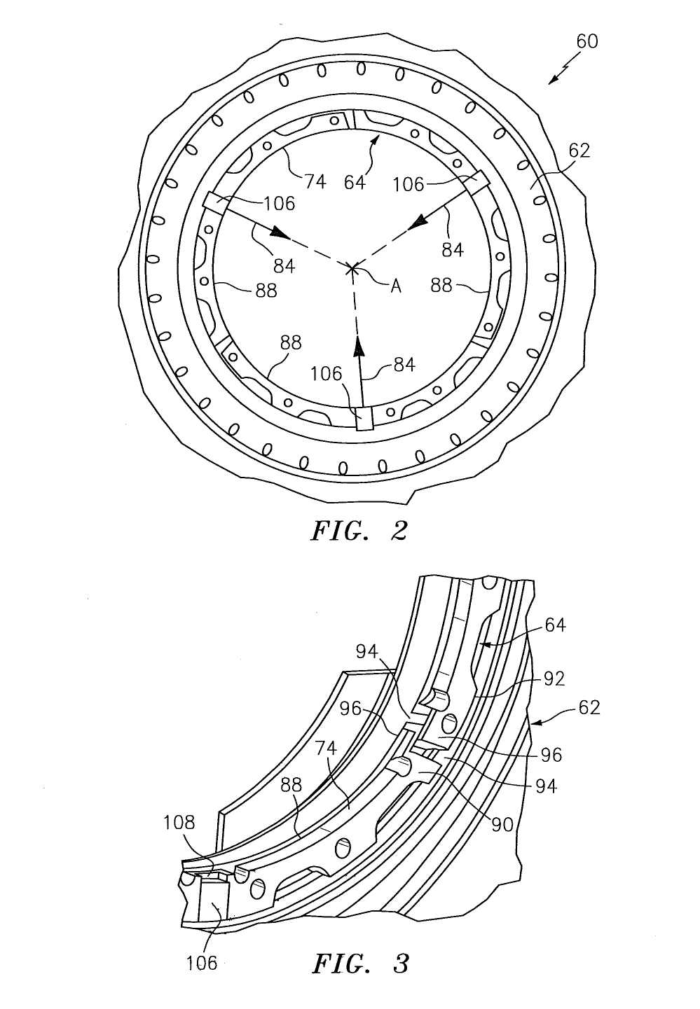

Referring to FIGS. 2 through 4, a seal assembly 60 is generally centered about the engine axis A. The assembly 60 may include a housing 62, a sacrificial or wearable seal ring 64 that may be made of carbon and is operably positioned within and supported by the housing, at least one spring 66 that may be a full hoop garter spring for biasing the ring 64 radially inward, and a plurality of circumferentially spaced, resilient, members 68 for biasing the ring 64 in an axial direction. At least one radial restrictor 70 of the assembly 60 is generally carried between the housing 62 and the ring 64 for limiting radial movement of the ring 64 within the housing 62. The ring 64 is biased radially inward to slideably seal against a substantially cylindrical face 72 that faces radially outward and is generally carried by the bearing structure 38. The face 72 and/or structure 38 is constructed and arranged to rotate about the axis A, and the housing 62 and the carbon seal ring 64 may be substantially stationary. It is contemplated and understood that the seal assembly 60 may prevent leakage of any fluid and not just oil as commonly used in a bearing structure. It is further understood that the structure 38 may be any moving structure in the gas turbine engine 20, which is only one, non-limiting, application of the assembly 60 which may be applied to applications other than a gas turbine engine.

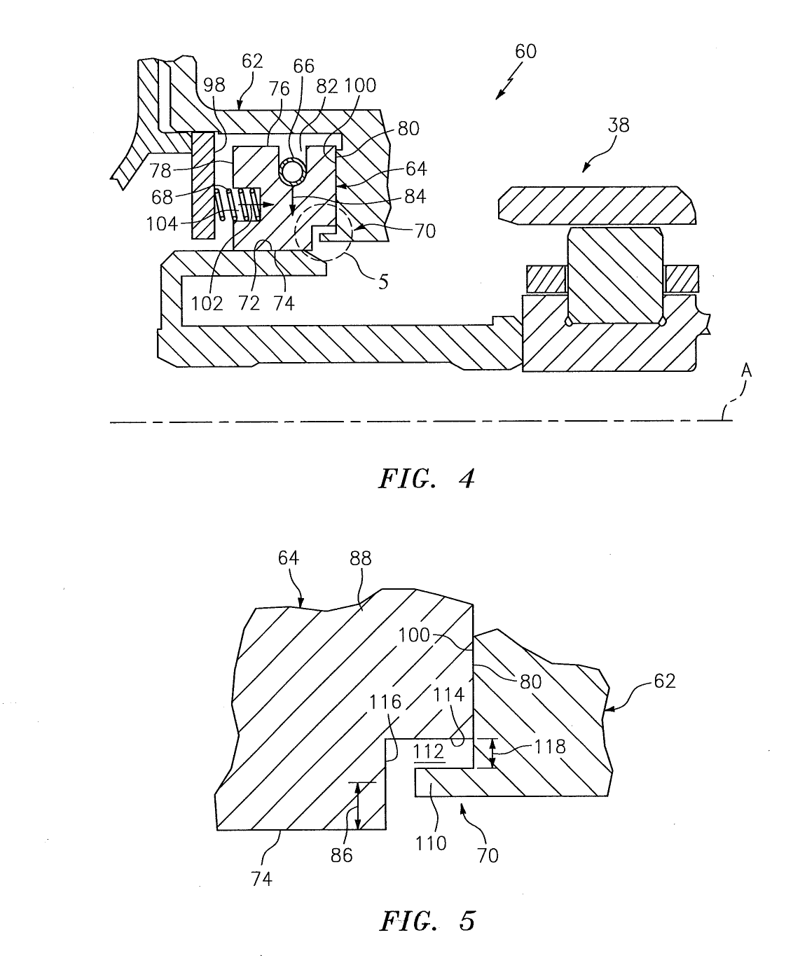

The carbon seal ring 64 may be generally rectangular or orthogonal in cross section and may carry substantially cylindrical surfaces 74, 76 that are opposite to one-another, and substantially annular surfaces 78, 80 that are opposite to one-another. The surface 74 may be the inner sealing surface that sealably rides upon the face 72 of the structure 38. The outer surface 76 may define a circumferentially continuous groove 82 for receipt of the garter spring 66. The garter spring 66 exerts a radially directed, inward, force (see arrows 84) that bias the inner surface 74 of the ring 64 against the structure face 72. The ring 64 is generally constructed to wear upon the cylindrical face 72 of the structure 38 by a pre-determined radial distance (see arrow 86 in FIG. 5) as the garter spring 66 continues to exert the radial force 84. The ring 64 may be made of any variety of carbon materials known in the sealing arts, and the structure 38 and/or face 72 may be made of a wear resistant titanium alloy or nickel alloy as two, non-limiting, examples.

The ring 64 may include a plurality of separate, arcuate, elements 88 (three illustrated in FIG. 2) each spanning circumferentially between adjacent elements to generally form the complete ring. Each element 88 has opposite end portions 90, 92 that oppose and may be slightly spaced circumferentially from the respective opposed end portion of the adjacent element 88. The end portion 90 of one element 88 may be circumferentially spaced from the opposed end portion 92 of the next adjacent element 88 defining a circumferential gap 94 therebetween. To minimize leakage, each end portion 90, 92 may have any variety of configurations known in the art of sealing. For example and as illustrated, each end portion 90, 92 may have circumferentially extending tabs 96 that generally overlap the tab of the opposed end portion. As the ring 64 wears and generally moves inboard, the gap 94 between elements 88 decreases.

The housing 62 of the carbon seal assembly 60 has substantially annular faces 98, 100 that are axially spaced apart and oppose one-another for receipt of at least a portion of the carbon seal ring 64 therebetween. At least one biasing member 68 is resiliently compressed between the face 98 of the housing 62 and the generally annular surface 80 of each respective element 88 of the ring 64. The members 68 may be coiled springs, and exert an axial force (see arrow 102) that biases the annular surface 80 of the ring 64 against the annular face 100 of the housing 62 for sealing contact. To assist in keeping the members 68 properly positioned, a portion of each member may be contained in a cavity or bore 104 in the element 88 and defined by the surface 78. It is further contemplated and understood that each element 88 may be associated with three or more, circumferentially spaced, biasing members 68 to evenly distribute the axial force 102 against each element 88.

As best shown in FIGS. 2 and 3, each element 88 may be associated with a respective guide rail 106 of the assembly 60 for guiding each element in a radial inward direction as the elements wear. Each rail 106 may be rigidly engaged to the housing 62, spans in a radial direction, and is generally located between the housing faces 98, 100. Each element 88 may generally define a channel 108 for receipt of the rail 106.

Referring to FIGS. 4 and 5, the radial restrictor 70 of the assembly 60 includes a protuberance 110 and a cavity 112 for receipt of the protuberance. The protuberance 110 may be rigidly engaged to and project axially from the annular face 100 of the housing 62 and generally toward the opposed face 98. Any variety of shapes may suffice as the protuberance 110. As one, non-limiting, example, the protuberance 110 may be a continuous, circumferentially extending rib, common to all of the elements 88. As another example, each element 88 may be associated with one, or preferably two or more, respective protuberances which may be circumferentially spaced pins or tabs.

The cavity(s) 112 in the ring 64 corresponds to the shape of the protuberance(s) 110 and may communicate through the sealing surface 80 of each element 88. When the ring 64 is in an unworn or new state as illustrated, the cavity 112 is larger than the protuberance 110. More specifically, each cavity 110 may be generally defined by a first wall 114 that faces radially inward and a second wall 116 that faces substantially axially and opposes the protuberance 110 and the housing sealing face 100. A distal end of the protuberance 110 is axially spaced from the second wall 116 to prevent any obstructive forces to occur as the ring 64 moves radially inward during the wear process. A clearance (see arrows 118) is defined radially between the protuberance 110 and the first wall 114. The clearance 118 prevents the protuberance 110 from snagging or obstructing ring 64 radial movement during the wear process. The clearance 118 or distance of the clearance is pre-determined and coincides with the pre-determined wear or radial distance 86. That is, the clearance 118 may be equal to or greater than the radial distance 86. Unlimited examples of cavity shapes may include a circumferentially continuous channel for receipt of a rib-like protuberance, or bores for receipt of a pin-like protuberance.

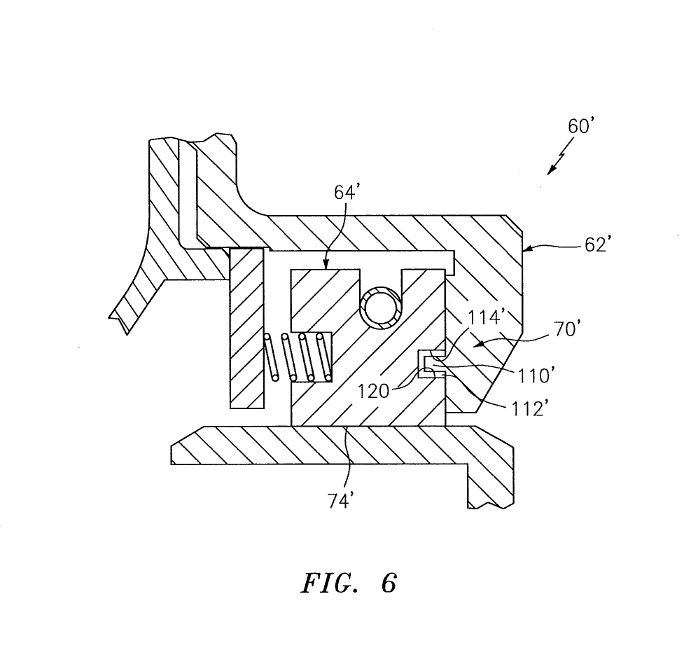

Referring to FIG. 6, a second embodiment of the carbon seal assembly is illustrated wherein like elements to the assembly 60 have like identifying numerals except with the addition of a prime suffix. The assembly 60′ of the second embodiment has a radial restrictor 70′ that includes a protuberance 110′ projecting outward from a housing 62′ and a cavity 112′ in a carbon seal ring 64′ for receipt of the protuberance 110′. Unlike the first embodiment, the cavity 112′ is spaced radially outward from a sealing surface 74′ of the ring 64′ and thus is defined by a third wall 120 that faces radially outward and is opposed to a first wall 114′. Although the cavity 112′ may be more difficult to manufacture than the cavity 112 of the first embodiment, the wear life of the ring 64′ may be greater than the wear life of the ring 64′ of the first embodiment because the axial width of the sealing surface 74′ is greater than the axial width of the sealing surface 74. It is further contemplated and understood that the protuberance 110′ may project rigidly from the ring 64′ and the cavity 112′ may be in the housing 62′.

During maintenance operations and/or assembly of the seal assembly 60, the radial restrictor 70 facilitates assembly by limiting the amount that the seal elements can drop (i.e. unintentional radially inward movement). This feature is particularly advantageous where radial clearances associated with the structure 38 are restrictive thus any unwanted, inbound, movement of the elements 88 may obstruct any axial insertion of various components of the structure 38.

During assembly of the seal assembly 60 (and generally prior to insertion of at least a portion of the structure 38), the garter spring 66 may be inserted into the housing 62. Once inserted each biasing member 68 may be compressed within the bore 104 of an element 88 of the ring 64. The element 88 with compressed member(s) 68 may be moved at an angle (i.e. in an axial and radially outward direction) to generally engage the radial restrictor 70 by inserting the protuberance 110 into the cavity 112. Further movement of the element 88 (i.e. radially outward movement) will then align the biasing member(s) 68 to the annular face 98 of the housing 62, and generally places the garter spring 66 into the groove 82 in the element 88. This process is repeated for each element 88 without worry that the previously installed element 88 will drop-out. When fully assembled, the radial restrictors 70 continue to hold the elements 88 in-place and against the biasing force 84 of the garter spring 66. The structure 38 may then be inserted axially through the assembly 60 with no or minimal obstruction from the seal ring 64.

While the invention is described with reference to exemplary embodiment(s), it will be understood by those skilled in the art that various changes may be made and equivalents may be substituted without departing from the spirit and scope of the invention. Therefore, different modifications may be made to adapt the teachings of the invention to particular situations or materials, without departing from the essential scope. The invention is thus not limited to the particular examples and/or disclosed structures, but includes all embodiments falling within the scope of the appended claims, which scope is accorded the broadest interpretation so as to encompass all such modifications, equivalent structures and methods. Moreover, although particular step sequences may be shown, described, and claimed, it is understood that steps may be performed in any order, separated or combined unless otherwise indicated and will still benefit from the present disclosure. It is further understood that when the language “at least a portion,” “a portion,” and/or “at least in-part” is used in the claims, the item may include a portion and/or the entire item unless specifically stated to the contrary.

1. A seal assembly comprising:
a housing orientated about an axis;
a wearable seal ring supported by the housing; and
a radial restrictor constructed and arranged between the housing and the seal ring, the radial restrictor including an axially projecting protuberance rigidly engaged to one of the housing and the seal ring, and a cavity defined by the other of the housing and the seal ring for receipt of the protuberance, and wherein a clearance directly adjacent to and radially outward from the protuberance and within the cavity is equal to or greater than a pre-determined radial wear distance of the ring seal when the ring seal is in an unworn state.

2. The seal assembly set forth in claim 1, wherein the seal ring includes a plurality of carbon elements each extending circumferentially.

3. The seal assembly set forth in claim 2, wherein the radial restrictor is one of a plurality of radial restrictors and each one of the plurality of carbon elements is associated with at least a respective one of the plurality of radial restrictors.

4. The seal assembly set forth in claim 3, wherein the plurality of carbon elements is at least three carbon elements.

5. The seal assembly set forth in claim 2 further comprising:
a structure in rotational relationship to the seal ring, and including a substantially cylindrical sealing face facing radially outward for sealing contact with an inward surface of the seal ring.

6. The seal assembly set forth in claim 5, wherein the structure is a bearing structure orientated about a rotating spool of a gas turbine engine.

7. The seal assembly set forth in claim 5 further comprising:
a full hoop garter spring biased against an outward surface of the seal ring disposed opposite the inward surface for biasing the inward surface against the outward face.

8. The seal assembly set forth in claim 2 further comprising:
a plurality of axially biasing members resiliently disposed between a radial first face of the housing and an opposed radial first surface of the seal ring for biasing a radial second surface of the seal ring disposed opposite the first surface toward a radial second face of the housing axially opposed to the first face.

9. The seal assembly set forth in claim 8, wherein the radial restrictor is carried between the second surface and the second face.

10. The seal assembly set forth in claim 9, wherein the protuberance rigidly projects axially from the second face.

11. The seal assembly set forth in claim 10, wherein the cavity communicates through the second surface.

12. The seal assembly set forth in claim 11 further comprising:
a structure in rotational relationship to the seal ring, and including a substantially cylindrical sealing face facing radially outward for sealing contact with an inward surface of the seal ring, and wherein the cavity is spaced radially outward from the inward surface.

13. The seal assembly set forth in claim 11 further comprising:
a structure in rotational relationship to the seal ring, and including a substantially cylindrical sealing face facing radially outward for sealing contact with an inward surface of the seal ring, and wherein the cavity communicates through the inward surface.

14. The carbon seal assembly set forth in claim 9, wherein the protuberance is a circumferentially continuous rib and the cavity is a circumferentially continuous channel.

15. A seal assembly comprising:
an annular housing orientated about an axis;
a plurality of sealing elements distributed circumferentially within the housing;
a spring constructed and arranged to bias the plurality of sealing elements radially inward;
a plurality of resilient members, wherein at least one of the plurality of resilient members biases a respective one of the plurality of sealing elements axially against the housing; and
a plurality of radial restrictors, wherein at least one of the plurality of radial restrictors is carried between the housing and a respective one of the plurality of sealing elements.

16. The seal assembly set forth in claim 15, wherein the plurality of sealing elements are compressed axially between a first face of the housing and a first surface of each one of the plurality of sealing elements and a second surface of each one of the plurality of sealing elements is opposite the first surface and is biased against an annular second face of the housing that is opposed to the first face.

17. The seal assembly set forth in claim 16, wherein the second surface is in sealing relationship to the second face and is constructed and arranged to slide radially with respect to the second face as the plurality of sealing elements wear.

18. The seal assembly set forth in claim 17, wherein each one of the plurality of radial restrictors include an axially projecting protuberance rigidly engaged to one of the second face and the second surface, and a cavity communicating through the other of the second face and the second surface for receipt of the protuberance, and wherein a clearance directly adjacent to and radially outward from the protuberance and within the cavity is equal to or greater than a pre-determined radial wear distance of the carbon ring seal when the carbon ring seal is in an unworn state.

19. A method of assembling a seal assembly comprising the steps of:
initiating a radial restrictor carried between an axially facing first surface of a sealing element and an axially facing first face of a housing via insertion of the sealing element into the housing; and
biasing the first surface toward the first face via a resilient member.

20. The method as set forth in claim 19, wherein the resilient member is compressed between a second face of the housing opposed to the first face and a second surface of the sealing element disposed opposite the first surface.
